(19) United States
(12) Patent Application Publication
(10) Pub. No.: US 2025/0242663 A1
(43) Pub. Date: Jul. 31, 2025

(54) BURNER ASSEMBLY FOR A MOBILE HEATING DEVICE AND INSERT COMPONENT WITH RETAINING RING FOR AN EVAPORATOR

(71) Applicant: Webasto SE, Stockdorf (DE)

(72) Inventors: Vitali Dell, Stockdorf (DE); Noah Winkeljann, Stockdorf (DE)

(21) Appl. No.: 19/041,005

(22) Filed: Jan. 30, 2025

(30) Foreign Application Priority Data
Jan. 30, 2024 (DE) 10 2024 200 836.2

(51) Int. Cl. B60H 1/22; F23D 11/02; F23D 11/36; F23K 5/22; F23Q 7/06

(52) U.S. Cl. CPC B60H 1/2203; F23D 11/02; F23D 11/36; F23Q 7/06; F23K 5/22

(57) ABSTRACT

Burner assembly (1) for a mobile fuel-operated heating device, in particular for a vehicle, comprises an evaporator (20) which is configured to evaporate a fuel supplied to it, an evaporator receptacle (24) which is configured to receive the evaporator (20), a circumferential wall (16) which defines a combustion chamber (14) in which a gas mixture containing the evaporated fuel may be combusted, wherein the circumferential wall (16) defines a central axis (M), a glow plug (10) with a shaft section (12) comprising a glow element, which is configured to convert a current flowing through it, when a voltage is applied, into heat for igniting the gas mixture, and a first opening (15) which is formed in the circumferential wall (16) of the combustion chamber (14) and through which the shaft section (12) of the glow plug (10) extends substantially radially into the combustion chamber (14). A holder arrangement (44, 45, 46, 17, 8) for the glow plug (10) is configured to allow a pivotability of the shaft section (12) of the glow plug (10) within the combustion chamber (14) in a direction (R) along the central axis (M) away from the evaporator (20). A corresponding insert component with an integrally formed retaining ring for the evaporator is also provided.

### TECHNICAL FIELD

The present invention relates to a burner assembly for a mobile, combustion-based heating device, in particular in a vehicle, and to an insert component with a retaining ring for an evaporator, which can be used in such a burner assembly.

### TECHNICAL BACKGROUND

It is known that burner assemblies are used in evaporator burners, as are frequently used in vehicles, for example as stationary or auxiliary heaters, etc. These are operated with liquid fuel. In such evaporator burners, liquid fuel is introduced into an evaporator via a fuel supply line. Structures used as evaporators may comprise, for example, non-woven metal fabrics and metal meshes and knitted metal fabrics or basalt wool, etc. In particular, the structure of the evaporator used has a multiplicity of cavities, such that the liquid fuel is absorbed by the evaporator by a capillary action and fuel is passed through the evaporator. In order to be able to start a combustion process in an evaporator burner, heat must initially be supplied to the evaporator via an external heat source. This is usually provided by an electrically operated glow element or glow plug, which initiates the starting process.

In this case, for the purpose of a rapid and very efficient supply of heat, the glow plug is arranged in a corresponding combustion chamber as close as possible to the evaporator in a fixedly predefined position. A conventional example of such an arrangement is shown in FIG. 1 with reference to a burner assembly 100. A combustion chamber 14 is fixed by a circumferential wall 16. On the end face, an evaporator 20 is received in an evaporator receptacle 24 and held by a holding element 30 integrated therein. The evaporator 20 is supplied with fuel via a fuel supply line 22. A method of assembly in the axial direction (joining direction) which greatly simplifies production is taken into account by an axial arrangement of a glow plug 10. One disadvantage is that the evaporator 20 is locally interrupted in this case in order to allow the passage of the glow plug 10 into the combustion chamber 14. The secure and spatially fixed positioning of the glow plug 10 is ensured by a plug socket 90.

An arrangement of a burner assembly 200 according to a conventional example which reduces the complexity of the evaporator 20 is shown in FIG. 2. The same reference symbols are used for identical or similar components or elements. In contrast to the example from FIG. 1, the glow plug 10 is in this case mounted radially and extends radially from a circumferential wall which is formed in the evaporator receptacle 24 into the inner space thereof, which circumferential wall is hereby part of the combustion chamber 14. The term “radially” may also include deviations from an exact perpendicular to a central axis of the combustion chamber 14 herein and rather denotes the lateral access to the combustion chamber 14, as can also be seen in FIG. 2. This access is also made possible here by a plug socket 90 which brings about secure and spatially fixed positioning of the glow plug 10 relative to the evaporator 20.

It should be noted that, as a result of the arrangement of the plug socket 90 laterally with respect to the evaporator receptacle 24, the axial length of the evaporator receptacle 24 is increased with respect to the burner flange 64. The corresponding projection is not available for the installation of elements of the heat exchanger (not shown), with the result that the overall length of the evaporator burner may be longer than necessary unless other measures are taken. An arrangement of the plug socket 90 on the circumferential wall 16 of the combustion chamber 14 would, on the other hand, complicate the axial joining direction of the components and entail additional folding processes, which increases the production costs and production time. An alternative design is therefore desirable.

It should also be noted that, instead of the rigid plug socket 90, screw bushes which interact with screw threads provided on the glow plug are also known in prior art. In the case of the plug socket 90, split pins are often provided for securing against falling out or for latching into a fixed position. After such split pins have been removed, the glow plugs can be moved and pulled out of the plug socket.

The described fixing of a glow plug 10 with the aid of a plug or screw bush 90 forms a rigid design by which the glow plug 10 is held reliably and precisely at a desired position or orientation in relation to the evaporator 20 and the combustion chamber 14. However, this once fixed position can only take account of changed conditions to a limited extent in the case of different operating durations and in the case of different operating settings.

### SUMMARY OF THE INVENTION

The present invention is therefore based on the object of providing a burner assembly or individual components thereof, in which the above-described disadvantages are avoided or at least reduced.

According to various aspects of the invention, a burner assembly for a mobile heating device, in particular for a vehicle, is proposed. The burner assembly comprises an evaporator, an evaporator receptacle, a circumferential wall with a first opening, a glow plug, and a holder arrangement for the glow plug.

The evaporator is configured to evaporate a fuel supplied to it. The invention is not limited to specific types or shapes of evaporators. The evaporator may be embodied in a disk-shaped manner. It may be formed from a porous non-woven fabric, mesh, knitted fabric, and/or woven fabric, in particular metal (fiber) non-woven fabric, metal mesh, knitted metal fabric, woven metal fabric, and/or metal sponge, or at least partially from a textile fiber molded body. Basalt wool is likewise suitable. As an alternative or in addition to metal, other (heat-resistant) materials, such as, for example, plastic and/or ceramic, may also be used therein. In particular, the evaporator may be produced at least partially from a porous, heat-resistant metal, preferably at least partially from steel, in particular a (e.g. 1.4841 or 1.4767) stainless steel alloy. The diameter of the evaporator may be, for example, between 20 mm and 80 mm and the thickness may be, for example, between 0.7 mm and 5 mm, all details without limiting the generality of the aspects described herein. The evaporator may be configured in a multi-stage manner, for example with a porosity or materiality (evaporator dome) which changes in a cascade-like manner. The fuel may be any desired fuels which are still liquid in the supplied state, for example diesel, gasoline, ethanol, kerosene or the like.

The evaporator receptacle is configured to receive the evaporator. In this case, the evaporator may be pressed into the evaporator receptacle, for which purpose the evaporator receptacle provides a corresponding cavity, the shape of which corresponds to that of the evaporator. The evaporator and the evaporator receptacle are, in particular, separate components.

The circumferential wall fixes a combustion chamber in its interior, in which combustion chamber a gas mixture containing the fuel (evaporated by the evaporator) may be combusted. The circumferential wall is preferably of cylindrical configuration, but the aspects of the invention are not restricted to the specific shape and configuration. According to exemplary embodiments, air inlet holes may be provided in the circumferential wall, on the one hand radially directed air inlet holes, on the other hand those which, in interaction, generate a swirl for better mixing of the gas mixture. According to optional embodiments narrowing regions, a flame tube, and channels of a heat exchanger, etc. may adjoin the circumferential wall in a downstream direction in a known manner.

The circumferential wall fixes a central axis M. Depending on the design, this axis may be a cylinder axis or another axis of symmetry. However, symmetry does not necessarily have to be provided. The central axis extends along a total flow direction of the gases flowing through.

The glow plug is provided with a shaft section comprising a glow element, which is configured to convert a current flowing through it, when an electrical voltage is applied, into heat for igniting the gas mixture. The glow plug may comprise a head with electrical connection electronics and the shaft section. Optionally, the shaft section may partially comprise a sleeve made of metal or ceramic, which protects against mechanical damage, etc., in a first opening.

The first opening may be formed in the circumferential wall, through which the shaft section of the glow plug extends substantially radially into the combustion chamber. The opening is not a bushing. The cross section of the first opening may roughly correspond to the cross-sectional profile of the shaft section or of the abovementioned further section, but a spatial fixing is not brought about thereby. As described, “radially” denotes the type of design with a lateral insertion direction of the glow plug, just in contrast to an axial design. This means that “radially” does not strictly require an orientation perpendicular to the central axis M of the combustion chamber.

Aspects of the invention now provide a holder arrangement for the glow plug, which holder arrangement can replace the conventional bushing, in particular plug socket or screw bushing, such that the burner assembly preferably does not comprise a plug socket or screw bushing. This holder arrangement is configured to allow a pivotability of the shaft section of the glow plug within the combustion chamber in a direction R along the central axis M away from the evaporator and/or towards the latter.

As described, a glow plug fixing in the conventional case is oriented fixedly or rigidly by the bushing and cannot adjust to changed conditions, or vary, over the operating or service life. Thus, for example, in the case of gasoline burners, undesired deformations of the evaporator can occur over its operating or service life due to deposits and residues. It has been found that, depending on the type, optimal orientations and positionings for the glow plug are suitable in which the distance from the evaporator is so small that the deformations lead to a contact between the evaporator and the glow plug, or the shaft section thereof. This finding is also associated with ever longer service lives of the burner assemblies and evaporator burners, which are achieved by quality improvements in the products.

The increasing contact between the evaporator and the glow plug leads, as time progresses, to the evaporator exerting a force Fd1 on the shaft section and threatening to push it in the direction of the central axis. In the conventional case of rigid fixing by bushings, this may lead to material fatigue and fracture of the shaft section, with the consequence that the evaporator burner becomes inoperable. Alternatively, the shaft section may not be subject to fracture, but may be surrounded by deposits, which however likewise leads to inoperability.

By contrast, the holder arrangement provided according to the present aspects now allows a deflection of the shaft section in the direction away from the evaporator. As a result, even after a longer operating or service life, the function of the glow plug is maintained, at least as long as the overall deformation does not lead to an impairment of the available combustion chamber.

Due to the first opening in the circumferential wall, through which the shaft section extends, the latter may form a type of pivot point for the allowed pivoting movement. The holder arrangement arranged outside the combustion chamber forms, in relation to the glow plug, a rear mounting support thereof which allows the pivoting movement. The pivotability leads to a rotational movement being performed, the direction R away from the evaporator therefore corresponding to a circular movement. Since the compensating movement in relation to the growth deformation of the evaporator involves only small angles—given more or less radial arrangement initially—with regard to the positional adaptation, without limiting the generality of the aspects described herein, by a pivoting range of a total of 20° or less, or even 15° or less, for example 10° or less, it may be spoken of a pivoting movement of the shaft section which is substantially parallel to the central axis M, if appropriate, for the purposes of the present application.

The holder arrangement may have any desired design in the general case considered here. Exemplary embodiments to be described further below provide, in addition to the first opening therein, a second opening which forms a second bearing for the glow plug, but which now allows a linear movability for a rear section of the glow plug. Those embodiments provide an active guidance of the rear section of the glow plug by a spring tension which is directed in the direction of the degree of freedom of the linear movement and, as a result, presses the shaft section in the direction of the evaporator—in the case of contact against the deformation force Fd1. Since the tension force Fs of the spring element is less than the deformation force Fd1, the shaft section recedes, but the spring force Fs holds the shaft section in position close to the evaporator.

It should also be noted that, instead of the described mounting support of the glow plug in the first opening as a pivot point and of the second opening of the holder arrangement as a mounting support or bearing, with a remaining degree of freedom of a linear movement, conversely, the mounting support or bearing point of the holder arrangement may alternatively be designed as a pivot point, while the glow plug may then move linearly in the first opening—with the same consequence as described above. For example, a sliding sliding element may be provided in the first opening which is then configured, for example, as an elongated hole, which sliding sliding element receives the shaft section and is moved therewith—e.g. under spring tension or against friction, specifically around the pivot point of the holder arrangement—and which at the same time covers exposed regions of the first opening for closing the combustion chamber.

The above description of the pivot point and the mounting support or bearing with linear movability serves merely for a simple description of the possibilities of how the holder arrangement according to the invention may be implemented in practice. Other options of movable mounting supports or bearings are likewise possible, for example a ball bearing, etc., in which the glow plug may be correspondingly mounted.

It should also be noted that diesel and gasoline burners are conventionally configured with mutually different distances of the glow plugs from the evaporator. As a result of the holder element which is provided separately from the combustion chamber wall, separate combustion chamber assemblies now no longer need to be configured for both types of burner, but rather it is sufficient to undertake the individual design merely via the holder arrangement.

Furthermore, as a result of the omission of the bushings, said bushings now no longer need to be welded to the evaporator receptacle or the combustion chamber wall in a complicated manner as individual components or to be configured as an integral component thereof, which saves costs, time and effort. As described, in addition, according to the aspects and exemplary embodiments, the service life of the evaporator burners is increased.

According to a specific development of the burner assembly, the holder arrangement may—as indicated above—comprise a spring element which is operatively connected to the glow plug and is configured to apply a spring force Fs to the glow plug, which spring force Fs presses the shaft section, preferably in the direction R toward the evaporator. As already described above purely by way of example, the glow plug is thereby held in position, but owing to the comparatively greater counterforce Fd1, said glow plug can recede in the opposite direction as a result of deformation of the evaporator and is thereby protected from damage and/or inoperability.

According to a further embodiment of the burner assembly, the holder arrangement comprises a holder element which is fixedly positioned in relation to the evaporator receptacle and/or the circumferential wall. The holder element comprises a second opening which lies opposite the first opening outside the combustion chamber in an at least partially overlapping manner, wherein the shaft section of the glow plug extends through the second opening. A largely radial positioning of the glow plug is thereby achieved. The second opening corresponds to the second mounting support or bearing point described above purely by way of example and in general terms.

According to a further embodiment of the burner assembly, a length of the second opening parallel to the central axis M is greater than a length of the first opening parallel to the central axis M. With the same shaft cross section at passage points through the two openings, the glow plug may thereby be movable within the second opening at least in a direction which lies substantially perpendicular to a direction in which it extends. By contrast, this is hardly the case or not the case in the first opening, but a fulcrum function of the first opening is maintained.

According to a corresponding embodiment of the burner assembly, the shaft section has a cross-sectional profile, wherein the second opening has an opening area which is greater than the cross-sectional profile.

According to a further embodiment of the burner assembly, the first opening has a first contact surface and the second opening has a second contact surface, wherein the first contact surface and the second contact surface delimit the respective openings on the side facing away from the evaporator, wherein the spring element is configured to exert the spring force Fs on the shaft section of the glow plug and thereby to press the latter against or towards both contact surfaces. In particular, the spring element may exert its spring force Fs perpendicularly to the direction of extent of the glow plug and thus exert a lever force on the shaft section positioned in the combustion chamber in the direction toward the evaporator. This is a particularly simple design.

According to a further embodiment of the burner assembly, a position of the second contact surface projected onto the central axis M and a position of the first contact surface projected onto the central axis M substantially coincide. A virtually ideal radial basic position is thereby achieved, which is only cancelled when the evaporator comes into contact with the shaft section of the glow plug and drives the shaft section in the direction of the central axis. In this case, the shaft section (or the further section, if present) detaches from the second contact surface against the tension force of the spring element, while the contact with the first contact surface (as a fulcrum) is maintained.

According to a further embodiment of the burner assembly, the holder element is configured integrally with a retaining ring which is configured to hold and to press the evaporator in the evaporator receptacle. This and the following specific aspects are particularly advantageous because the implementation of the holder arrangement may be carried out particularly simply with few components and in a volume-saving manner. The holder element and the retaining ring may form an insert component for the burner assembly jointly and in an integral manner. For example, the combined element of retaining ring for the evaporator and holder element for the glow plug may be produced from a single coherent deep-drawn insert plate. By combining a plurality of functions in one component, the number of individual parts and the quantity of required welding processes in the series may also be reduced and the assembly may thus be simplified. Furthermore, the possibility of an overall assembly from only one single direction is ensured by the integral component of the retaining ring and the holder element.

A refinement provides that the retaining ring furthermore has an all-round flange portion which is received between a burner flange that is formed integrally with the circumferential wall and an evaporator receptacle flange and is preferably welded thereto. By means of the integral retaining ring with flange, an end-face boundary of the combustion chamber may be axially displaced in the design such that the evaporator receptacle no longer delimits the combustion chamber (cf. in this respect FIG. 2). The retaining ring with flange is thus now located completely therebetween. Supported by an external regulation, the heat balance in the evaporator may thus be better regulated and the burner with this concept may be used for different fuels. In the case of the integrally configured insert component or specifically of the insert plate, said insert component may be placed between the flanges of the evaporator receptacle and the combustion chamber and all three components are connected non-releasably by a uniform welding operation. The wall thickness of the sheet metal part is preferably selected to be as small as possible in order to ensure a welding that meets the requirements.

The holding element may thereby extend outwardly from the flange section. In order to extend up to the section of the circumferential wall comprising the first opening downstream (in the direction of the combustion chamber outlet or flame tube), the holding element may be correspondingly bent by e.g. 90°. The second opening is formed in the holding element and the bending is carried out in such a manner that the two openings lie opposite one another at a suitable distance, i.e. the holding element may also be arranged approximately parallel to an outer surface of the circumferential wall. As a result of the integral configuration with the retaining ring and the flange section, the position and orientation of the holding element is robust and durable.

A refinement of this aspect of the burner assembly provides that the retaining ring furthermore has a cylindrical section and a holding section which adjoins the cylindrical section and has an inner opening, that the cylindrical section and the holding section together form a pot shape which, opposite the evaporator receptacle, also receives the evaporator and presses said evaporator. As a result, the dual function of the retaining ring with holding element is completed.

A further improvement may be achieved if the inner opening is closed by a grid through which the evaporated fuel can pass. The grid may hold, in particular, fiber-like evaporator materials or else basalt wool, etc., in shape.

A further aspect of the invention provides an insert component for a burner assembly for a mobile heating device. In a preferably integral configuration, the insert component comprises:
a retaining ring for an evaporator with holding section for pressing the evaporator in an evaporator receptacle of the burner assembly, with an inner opening for releasing a fuel evaporated by the evaporator into a combustion chamber of the burner assembly and with a flange section for fastening the retaining ring to a burner flange that is formed integrally with a circumferential wall of the combustion chamber and to an evaporator receptacle flange; and
a holder element for holding a glow plug outside the combustion chamber and for determining an orientation of a shaft section of the glow plug within the combustion chamber.

The advantages are the same as described above in relation to the integral retaining ring in the burner assembly. However, this aspect of the invention is not necessarily restricted by the pivotability of the glow plug. In particular, the first and the second opening may also be of the same size. Nevertheless, some of the abovementioned advantages are achieved. The further features described above in relation to the retaining ring and the holder arrangement with the holder element may also be implemented in this aspect.

### BRIEF DESCRIPTION OF THE DRAWINGS

The invention is explained below by way of example with reference to the following figures.

In the figures:

FIG. 1 shows a sectional view through a burner assembly according to a first example according to prior art with an axial arrangement of the glow plug;

FIG. 2 shows a sectional view through a burner assembly according to a second example according to prior art with a radial arrangement of the glow plug;

FIG. 3 shows a sectional view through a burner assembly according to an embodiment with a radial arrangement of the glow plug;

FIG. 4A shows a perspective illustration of the spring element from FIG. 3;

FIG. 4B shows an enlarged illustration of the elements of the holder arrangement from FIG. 3, without a glow plug;

FIG. 5 shows another enlarged illustration of the elements of the holder arrangement from FIG. 3, with a glow plug;

FIG. 6 shows a schematic illustration of the mutually opposite openings of the holder arrangement with possible resulting pivot positions of the glow plug;

FIG. 7 as FIG. 3, but in a perspective sectional illustration; and

FIG. 8 shows an insert component with a retaining ring and with an integrally formed holder element according to an embodiment.

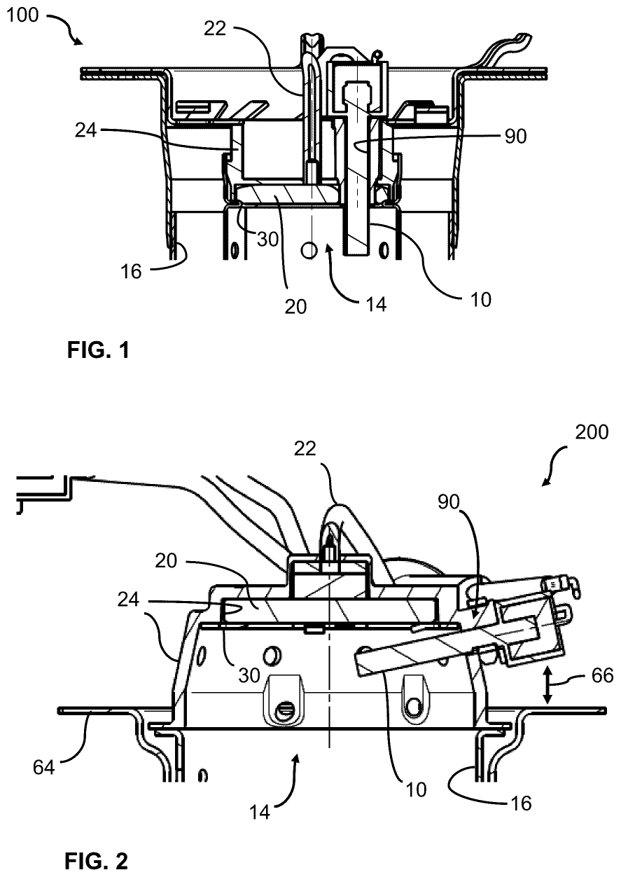

### DETAILED DESCRIPTION OF PREFERRED EMBODIMENTS

In the following description of the drawings, identical reference symbols designate identical or comparable components.

The features of the invention disclosed in the above description, in the drawings and in the claims may be essential for the implementation of the invention both individually and in any desired combination.

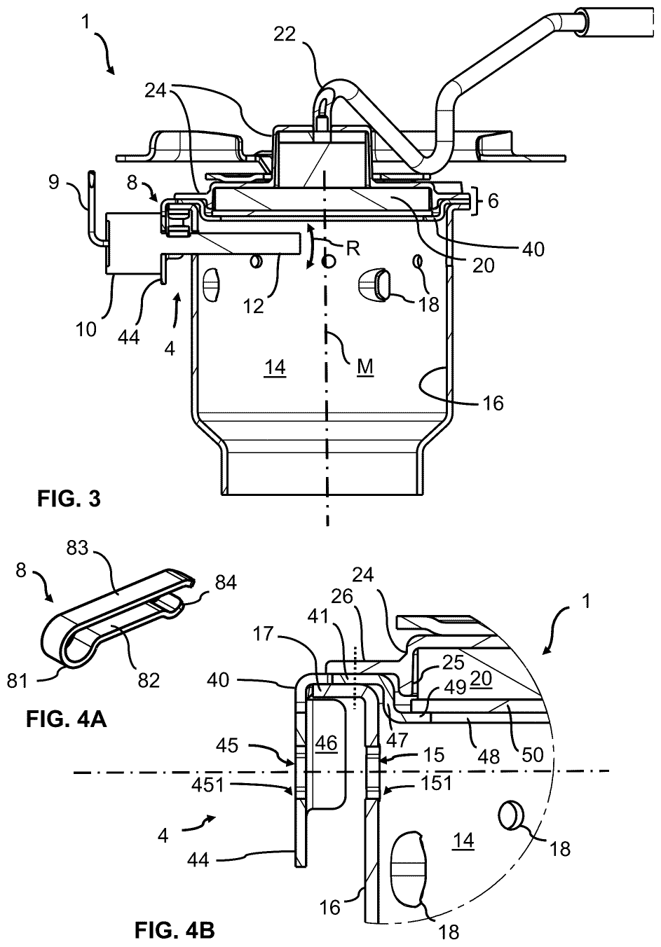

FIG. 3 shows a sectional view through a burner assembly 1 according to an embodiment with a radial arrangement of the glow plug 10. The burner assembly 1 comprises a combustion chamber 14 which is fixed by a cylindrical circumferential wall 16, an evaporator receptacle 24, an evaporator 20 received therein and a retaining ring 40 with a holder element 44 formed integrally with the retaining ring 40. The combustion chamber 14 or the circumferential wall 16 defines a central axis M. Comparatively small, radially directed air introduction holes 18 as well as further air introduction holes 18 generating a swirl, so-called flaps, are formed in the circumferential wall 16. The combustion chamber 14 tapers in the downstream direction (downward in FIG. 3). The evaporator receptacle 24 has an enclosure 25 with a pot-shaped receptacle for the evaporator 20. The evaporator 20 is pressed into this receptacle. Without limiting the generality of the aspects described herein, the evaporator 20 may be basalt wool. An evaporator dome, in which a further evaporator (without reference symbols) with a different porosity may be introduced, is formed in the evaporator receptacle 24 above the evaporator 20. During operation, a fuel such as gasoline, diesel, ethanol, etc., may be supplied to the evaporator 20 via the evaporator dome via a fuel supply line 22.

The evaporator receptacle 24 forms, as a component, an end-face termination for the burner assembly 1. However, the combustion chamber 14 is delimited on the end face by the retaining ring 40 and a grid 50 (cf. FIG. 8) arranged therein above or within an inner opening 48, such that the evaporator receptacle 24 (advantageously) is no longer in direct contact with the combustion chamber 14. The retaining ring 40, together with the grid 50, has the task of maintaining the compression of the evaporator 20 in the evaporator receptacle 24. During operation, the supplied fuel is evaporated in the evaporator 20, and passes via the grid 50 into the combustion chamber 14, where it is mixed with the fuel flowing through the air introduction holes and is combusted, after initial ignition via the glow plug 10.

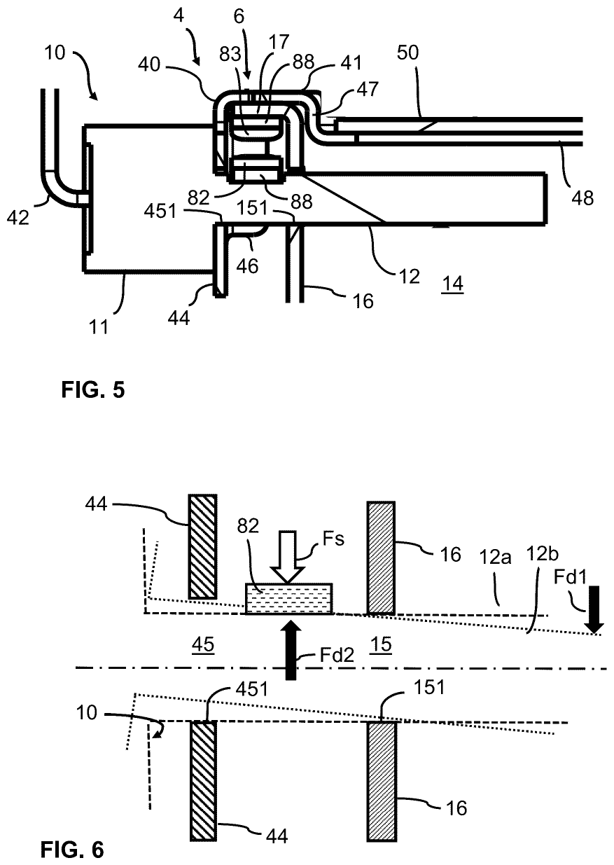

The glow plug 10 has a form known per se in this technical field. The glow plug 10 comprises a head 11 which, inter alia, comprises connection electronics. The glow plug 10 is supplied with electrical power via electrical connection lines 9. Furthermore, the glow plug 10 has a shaft section 12 which extends into the combustion chamber 14 in a substantially radial direction through a first opening 15 (cf. FIGS. 4B and 5) in the circumferential wall 16. The first opening 15 is designed as a mere recess in the combustion chamber wall without inner or outer structures. In particular, it is not designed as a plug or screw bush. A cross-sectional profile of the first opening 15 substantially corresponds to a cross-sectional profile of the shaft section 12 of the glow plug 10. The first opening 15 may be designed to be slightly larger than the cross-sectional profile of the shaft section 12 by the extent of a manufacturing tolerance and due to production-related roundings in the corners (cf. FIG. 8).

With reference to FIGS. 4A and 4B and 5, the holder arrangement 4 is described in greater detail. The holder arrangement 4 comprises a tab or holder element 44 for the glow plug 10, which tab or holder element integrally adjoins a flange section 41 of the retaining ring 40. The flange section 41 extends in a plane perpendicular to the central axis M of the combustion chamber 14 and parallel to a plane of extent of the evaporator 20 and parallel to a holding section 49 forming the opening 48 of the retaining ring 40 with the grid 50 arranged thereon. With the aid of a flat cylindrical section 47 of the retaining ring 40, the retaining ring 40 forms, basically like the evaporator receptacle 24, a flat pot shape which in turn receives a corresponding pot shape of the enclosure 25 of the evaporator receptacle 24 for receiving the evaporator 20 therein. Consequently, the retaining ring 40 has a relatively flat design.

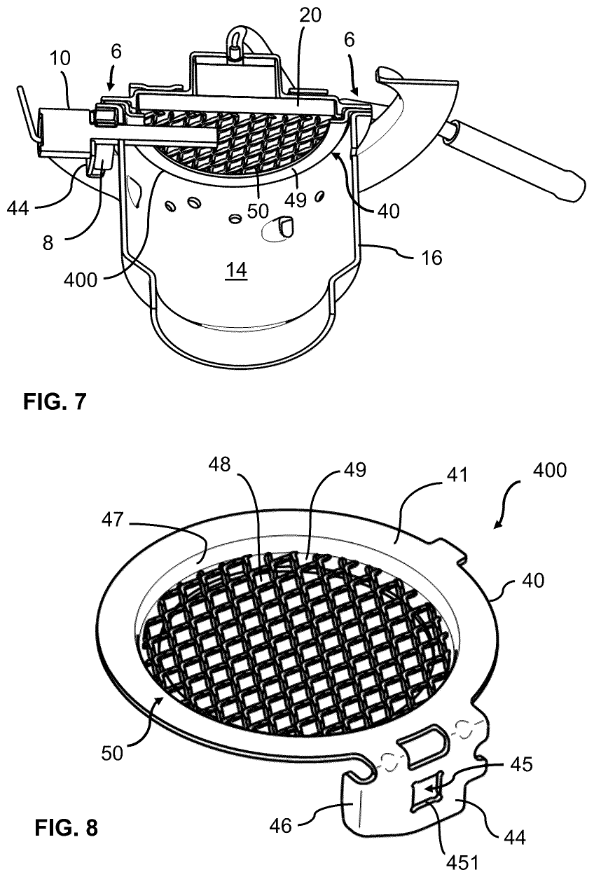

As indicated by the dotted line in FIG. 4B, the flange section 41 forms, jointly with a combustion chamber flange 17 and an evaporator receptacle flange 26, a flange package 6 (cf. FIGS. 3 and 7), the flange section 41 being enclosed by combustion chamber flange 17 and the evaporator receptacle flange 26 in a sandwiched manner. The dotted line indicates a weld seam in a schematic manner. The flange section 41 extends all-round in the retaining ring, so that an all-round closed connection with the combustion chamber flange 17 and the evaporator receptacle flange 26 is achieved.

Since the flange section 41 is exposed with its outer edge to an external environment, the tab-like holder element 44 may extend in an integrally configured manner from the flange section 41 into an external environment of the combustion chamber 14. As can be seen in the figures, the tab-like holder element 44 is bent by 90° in the downstream direction at a slight distance from the circumferential wall 16, in order to then extend parallel to the central axis M to the central axis M and to the circumferential wall 16.

The overall retaining ring 40 with the holding arrangement 4 and the holder element 44 is formed in the embodiment by a deep-drawn and bent, flat insert component. As can be seen in FIG. 4B, the wall thickness of the insert component (for example 0.8 mm) approximately corresponds to that of the circumferential wall 16 (for example 1 mm) of the combustion chamber 14. This also facilitates the welding of the abovementioned flange sections. A second opening 45 is formed in the tab-like holder element 44. As can be seen in FIG. 3 and FIG. 5, the shaft section 12 extends both through the first opening 15 and through the second opening 45. For the optional case in which the glow plug 10 comprises a metal or ceramic sleeve, it may be in direct contact with the openings 15, 45 as part of the shaft section 12 of the glow plug 10.

As can be seen in FIG. 5, a spring element 8, which can also be seen in FIG. 4A, is configured between the shaft section 12 and the combustion chamber 14. The spring element 8 is embodied here as a split pin which is compressed between the shaft section 12 and the combustion chamber 14. In other words, the spring element 8 exerts, supported on the combustion chamber flange 17, a tensioning force directed downward in FIG. 5 onto the shaft section 12, i.e. in the downstream direction or parallel to the central axis M and to the planes of the opening areas each of the first opening 15 and the second opening 45, and—depending on the current pivot position of the glow plug—substantially or approximately perpendicularly to the direction in which the glow plug 10 extends. As a result of this tension force, the shaft section 12 is pressed against corresponding contact surfaces 151, 451 of the first and second openings 15, 45.

As can be seen in FIG. 6, the first opening 15 has a smaller length in a direction parallel to the central axis M than the second opening 45. The length of the first opening 15 in the direction parallel to the central axis M approximately corresponds to the diameter of the shaft section 12, while the length of the second opening 45 in the direction parallel to the central axis M is greater than the diameter of the shaft section 12. As a result, the shaft section 12 can move in the second opening 45 in the direction parallel to the central axis M, which is not the case with respect to the first opening 45. This results in a possible rotational movement of the glow plug 10, such that the shaft section 12 can basically move toward or away from the evaporator 20, as indicated by the double arrow in FIG. 3, which indicates the corresponding rotational direction R, which is substantially parallel to the central axis M for small pivot ranges.

According to a specific non-limiting embodiment, as a result of the mutual arrangement and size of the openings 15, 45, the shaft section 12 may ideally be inclined toward the evaporator by 2° with respect to an exact radial direction perpendicular to the central axis in an initial state, in which the shaft section contacts the two contact surfaces 151 and 451, and may be inclined away from the evaporator by 8° with respect to an exact radial direction perpendicular to the central axis in a state, in which the shaft section 12 releases from the contact surface 451 and contacts an opposite contact surface 452 (maximum pivot range). The allowed pivot range is thus 10° in this case. The range is so small that it is scarcely visibly reflected by differences in length of the openings in FIGS. 3, 4B, 5 and 7, for which reason the difference is illustrated exaggerated in FIG. 6 in order to illustrate the effect.

The spring element 8 is embodied as a split pin as described. It can be seen in FIG. 4A that this split pin comprises a bulbous base section 81, a pressure section 82, a contact section 83 and an end section 84. The contact section 83 lies flat against the combustion chamber flange 17 in the installed state. In this state, the bulbous base section 81 or the end section 84 lies against a holding flange 46 which is bent once again by 90° toward the circumferential wall 16 by the tab-like holder element 44, in order to hold the spring element 8 in position. The end section 84 bulges like the base section 81 in the downstream direction in the installed state, i.e. downward in FIG. 4B, while the intermediate pressure section 82 biases the shaft section 12. In order to secure the radial position of the shaft section 12, the latter has a groove (not shown) into which the pressure section 82 may engage. A cooling lug 88 may be interposed between the pressure section 82 and the surface of the groove.

Returning to FIG. 6, in particular the pressure section 82 of the spring element 8 presses the shaft section 12 against the contact surfaces 151 and 451, such that the glow plug 10 assumes a predetermined position relative to the combustion chamber 14 and to the evaporator 20 despite its basic movability. Due to deposits during operation over the service life, the evaporator 20 may deform, and thereby come into contact, for example, with a distal region of the shaft section 12. As a result, a force Fd1 is exerted on the shaft section 12. The first opening 15 in this case forms a pivot point for the glow plug 10. Correspondingly, the force Fd1 exerted on the shaft section 12 is transformed into a lever force Fd2, with which the pressure section 82 of the spring element 8 is forced back against its own tension force Fs, which is designed to be significantly less. Nevertheless, this tension force Fs holds the glow plug 10 in position, wherein the distal region of the shaft section 12 is in contact with the continuously further deforming evaporator. This process continues over the service life. At the same time, the shaft section 12 is protected from damage.

FIG. 7 once again shows an overview of the burner assembly 1 as in FIG. 3, but in a perspective sectional view.

FIG. 8 shows an embodiment of an insert component 400 with an integrally formed retaining ring 40 and holder element 44 for the glow plug 10 and with a grid 50. The embodiment shown in FIG. 8 may be identical to the retaining ring 40 shown in FIGS. 3 to 7, so that the detailed description can be dispensed with.

However, it should be noted that, according to another aspect, the embodiment of an insert component 400 as shown in FIG. 8 can be modified in such a manner that the second opening 45 may certainly also be formed only with a cross-sectional area corresponding to the shaft section 12. In this case, the glow plug cannot be guided or moved laterally within the second opening 45. In other words, in this case, the spatial position of the glow plug 10 is substantially fixed and rigid. The spring element 8 shown in FIGS. 3, 4A, and 5-7 may therefore serve merely for fixing/securing the glow plug 10 in the holder arrangement 4 in the radial direction in this embodiment.

The modified embodiment may indeed not take account of the deformation of the evaporator 20 over the service life in interaction with the features of the burner assembly 1 shown in FIGS. 3, 4A, and 5-7 without movability of the glow plug. However, a simple and cost-effective insert component may advantageously still be realized which allows, on the one hand, a flat design of the evaporator receptacle 24 and thus a shortening of the overall length of the evaporator burner and, on the other hand, allows an axial assembly of the components for the evaporator. A complex production of plug or screw bushes may be dispensed with.

### LIST OF REFERENCE NUMERALS

1 burner assembly
4 holder arrangement (comprises the references 44, 45, 46, 17, 8)
6 welded flange package
8 spring element
9 electrical connection lines
10 glow plug
11 head
12 shaft section
14 combustion chamber
15 first opening
151 contact surface
16 circumferential wall (combustion chamber)
17 combustion chamber flange
18 air introductions holes
20 evaporator
22 fuel supply line
24 evaporator receptacle
25 enclosure (for evaporator in evaporator receptacle)
26 evaporator receptacle flange
30 holding element (conventional)
40 retaining ring (invention)
41 flange section
44 holding element
45 second opening
451 contact surface
46 holding flange (on holder arrangement for supporting the spring element)
47 cylindrical section
48 opening
49 holding section
400 insert component
50 grid
81 base section
82 pressure section
83 contact section
84 end section
90 bushing, plug socket
100 Evaporator burner (prior art): axial bushing for glow plug
200 Evaporator burner (prior art): radial bushing for glow plug
M Central axis
R (Pivoting) direction of the glow plug

1. A burner assembly for a mobile fuel-operated heating device for a vehicle, comprising:
an evaporator which is configured to evaporate a fuel supplied to the evaporator;
an evaporator receptacle which is configured to receive the evaporator;
a circumferential wall which defines a combustion chamber in which a gas mixture containing the evaporated fuel may be combusted, wherein the circumferential wall defines a central axis (M);
a glow plug with a shaft section comprising a glow element, which is configured to convert a current flowing through it, when a voltage is applied, into heat for igniting the gas mixture;
a first opening which is formed in the circumferential wall of the combustion chamber and through which the shaft section of the glow plug extends substantially radially into the combustion chamber;
characterized by
a holder arrangement for the glow plug, which holder arrangement is configured to allow a pivotability of the shaft section of the glow plug within the combustion chamber in a direction (R) along the central axis (M) away from the evaporator.

2. The burner assembly according to claim 1, wherein
the holder arrangement comprises a spring element which is operatively connected to the glow plug and is configured to apply a spring force (Fs) to the glow plug, which spring force (Fs) presses the shaft section, preferably in the direction R toward the evaporator.

3. The burner assembly according to claim 2, wherein
the holder arrangement comprises a holder element which is fixedly positioned in relation to the evaporator receptacle and/or the circumferential wall, wherein the holder element comprises a second opening which lies opposite the first opening outside the combustion chamber in an at least partially overlapping manner, wherein the shaft section of the glow plug extends through the second opening.

4. The burner assembly according to claim 3, wherein
a length of the second opening parallel to the central axis (M) is greater than a length of the first opening parallel to the central axis (M).

5. The burner assembly according to claim 3, wherein
the shaft section of the glow plug has a cross-sectional profile, wherein the second opening has an opening area which is greater than the cross-sectional profile.

6. The burner assembly according to claim 3, wherein
the first opening has a first contact surface and the second opening has a second contact surface, wherein the first contact surface and the second contact surface delimit the respective openings on the side facing away from the evaporator,
wherein the spring element is configured to exert the spring force (Fs) on the shaft section of the glow plug and thereby to press the latter against or towards both contact surfaces.

7. The burner assembly according to claim 6, wherein
a position of the second contact surface projected onto the central axis (M) further from the evaporator corresponds to a position of the first contact surface projected onto the central axis (M).

8. The burner assembly according to claim 3, wherein
the holder element is configured integrally with a retaining ring which is configured to hold and to press the evaporator in the evaporator receptacle.

9. The burner assembly according to claim 8, wherein
the retaining ring furthermore has an all-round flange portion which is received between a burner flange that is formed integrally with the circumferential wall and an evaporator receptacle flange and is preferably welded thereto.

10. The burner assembly according to claim 8, wherein
the retaining ring furthermore has a cylindrical section and a holding section which adjoins the cylindrical section and has an inner opening, the cylindrical section and the holding section together form a pot shape, which receives the evaporator receptacle positioned oppositely, and presses said evaporator.

11. The burner assembly according to claim 10, wherein
the inner opening is closed by a grid through which the evaporated fuel can pass.

12. A fuel-operated mobile heating device for a vehicle, comprising a burner assembly according to claim 1.

13. An insert component for a burner assembly for a mobile fuel-operated heating device, comprising:
a retaining ring for an evaporator with a holding section for pressing the evaporator in an evaporator receptacle of the burner assembly, with an inner opening for releasing a fuel evaporated by the evaporator into a combustion chamber of the burner assembly, and with a flange section for fastening the retaining ring to a burner flange that is formed integrally with a circumferential wall of the combustion chamber and to an evaporator receptacle flange; and
a holder element for holding a glow plug outside and for defining an orientation of a shaft section of the glow plug within the combustion chamber.

14. The insert component according to claim 13, wherein the retaining ring furthermore has a cylindrical section which extends in an axial direction between the holding section and the flange section.
